(19) United States
(12) Patent Application Publication
(10) Pub. No.: US 2005/0197842 A1
(43) Pub. Date: Sep. 8, 2005

(54) Vehicle with an instant messaging communications system

(76) Inventors: Carsten Bergmann, San Jose, CA (US); Klaus Schaaf, Braunschweig (DE); Chu Hee Lee, San Jose, CA (US); Zhaoxia Zhang, Mountain Veiw, CA (US)

Correspondence Address: Andreas Grubert;Baker Botts L.L.P., 910 Louisiana, One Shell Plaza, Houston, TX, 77002-4995, US

(21) Appl. No.: 11/071,515

(22) Filed: Mar. 3, 2005

Related U.S. Application Data
(60) Provisional application No. 60/550,157, filed on Mar. 4, 2004.

(51) Int. Cl. G10L 11/00; G10L 21/00; G06F 15/16

(52) U.S. Cl. 704/270.1; 709/206

(57) ABSTRACT

A vehicle comprises an instant messaging communications system for communication between an occupant of the vehicle and a communications participant via an instant messaging server, wherein the instant messaging communications system includes a communications module to receive an instant messaging message, containing a message string and a text-to-speech engine to translate the message string to an acoustic signal for emission by a loudspeaker.

This application claims priority to and is converted from U.S. Provisional Application 60/550,157 filed Mar. 4, 2004.

### TECHNICAL FIELD OF THE INVENTION

The present invention relates to a vehicle with an instant messaging communications system for communication between an occupant of the vehicle and a communications participant via an instant messaging server.

### DESCRIPTION OF THE RELATED ART

Instant messaging communications systems are known, for example, from WO 01/56308 A2 (incorporated by reference), WO 01/72020A2 (incorporated by reference), WO 03/0017182 A2 (incorporated by reference) and DE 101 16 246 A1 (incorporated by reference).

Instant messaging supported communication ordinarily occurs in similar fashion to exchange of email messages in writing by entering alphanumeric characters by means of a computer keyboard. It is also known from WO 01/72020 A2, to construct two-way speech connection between two communications subscribers by instant messaging.

The incorporation of telephone systems is known for communications from and to vehicles. Exchange of messages, for example, exchange of messages via SMS or email, on the other hand, appears to be rather unsuitable.

### SUMMARY OF THE INVENTION

The task of the invention is to improve communication from and to vehicles without adversely affecting traffic safety.

The aforementioned task is solved by a vehicle with an instant messaging communications system for communication between an occupant of the vehicle and a communications participant via an instant messaging server, for example, a Yahoo Messenger Server or an MSN Messenger Server, in which the instant messaging communications system includes a communications module to receive an instant message, containing a message string, and a text-to-speech engine to convert the message string to an acoustic signal, for example, to be emitted by a loudspeaker. This type of text-to-speech is offered by AT&T, for example, with Java API.

In another embodiment of the invention, a name of a sender of the instant messaging message and/or a buddy list can be converted to an acoustic signal by means of the text-to-speech engine. Buddy list can be understood to mean a list of other communications participants, with reference to instant messaging, who are online and are therefore available for exchange of instant messaging messages.

In another embodiment of the invention, the vehicle includes a display to display the message string. In another embodiment of the invention, a touch screen arranged on the display is provided, in which, by touching a position on the touch screen, beneath which the message string is depicted, a sender of the instant messaging message can be selected as receiver of an instant messaging message to be sent, and/or in which, by touching a position on the touch screen, beneath which an entry of a buddy list is depicted, said entry can be selected as the buddy list receiver of an instant messaging message to be sent.

In another embodiment of the invention, the vehicle also includes a microphone to convert a speech signal to an electrical recording signal. The instant messaging communications system, in another embodiment of the invention, includes a conversion module to convert the electrical recording signal to a file, especially an MP3 file.

In another embodiment of the invention, the instant messaging communications system includes a translation module to translate an entry of a buddy list from an alphanumeric form to acoustic information allocated to the entry of the buddy list and a selection module for comparison of a signal recorded by a microphone with the acoustic information assigned to the entry of the buddy list, and for selection of the entry of the buddy list as a receiver of an instant messaging message to be sent during essential agreement of the signal recorded by the microphone with the acoustic information assigned to the entry of the buddy list.

For translation of the name into the form of acoustic information, a so-called grapheme-to-phoneme method is advantageously used. Details concerning such a method can be gathered, for example, from article published on the internet page www2.rz.huberlin.de/compling/Lehrstuhl/Skripte/CL_{—}2_Speech/Speech-98-121.pdf, as well as the Internet site www.speech.kth.se/qpsr/tmh/2002/02-44-117-120.pdf “Grapheme-to-phoneme conversion, a knowledge based approach” by Niklas Torstensson, Dept. of Languages, Skövde College, TMH-QPSR Vol. 44—Fonetik 2002. Additional details concerning a grapheme-to-phoneme method are disclosed in the article published on the Internet page acl.ldc.upenn.edu/E/E93/E93-1007.pdf, “Data-oriented Methods for Grapheme-to-Phoneme Conversion”, by Antal van den Bosch and Walter Daelemans, ITK, Tilburg University, and on the Internet page www.ub.rug/nl/eldoc/dis/science/i.p.stoianov/c5.pdf.

Vehicles according to the invention are especially a land vehicle, usable individually in traffic. Vehicles according to the invention are not restricted, in particular, to land vehicles with an internal combustion engine.

### BRIEF DESCRIPTION OF THE DRAWINGS

Additional advantages and details are apparent from the following:

FIG. 1 shows a practical example of a set of several communications participants communicating with each other via an instant messaging server;

FIG. 2 shows a practical example for an instant messaging communications system;

FIG. 3 shows an embodiment of a display that can be displayed by means of a display device;

FIG. 4 shows a practical example for a method for transferring a speech message;

FIG. 5 shows another practical example for an instant messaging communications system;

FIG. 6 shows allocation of information in acoustic format to its information content; and

FIG. 7 shows another allocation of information in acoustic format to its information content.

### DETAILED DESCRIPTION OF THE PREFERRED EMBODIMENTS

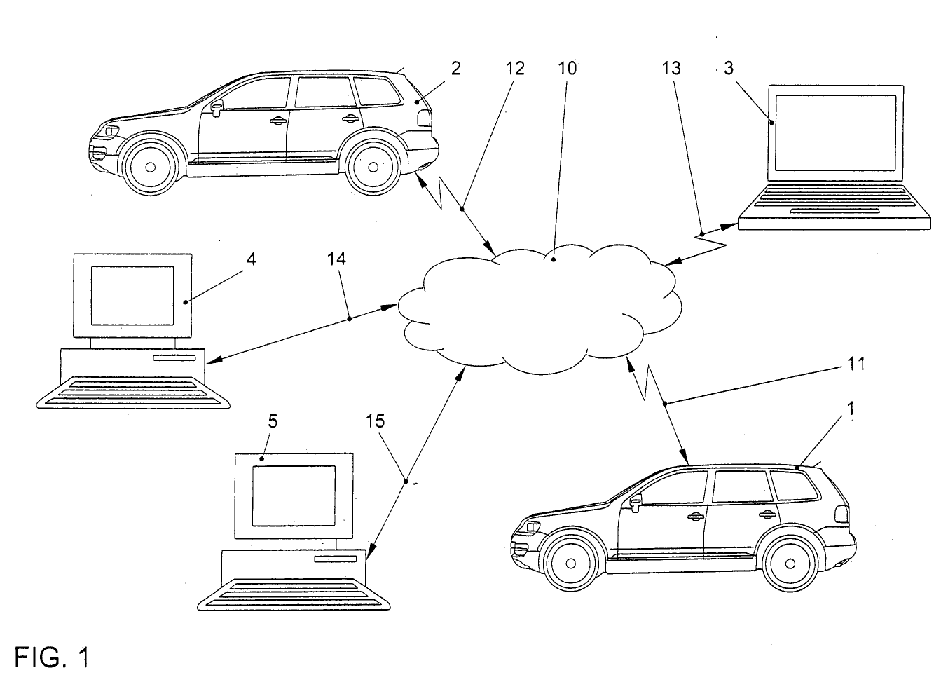

FIG. 1 shows two vehicles 1 and 2, a notebook 3 and two computers 4 and 5. Vehicles 1 and 2, notebook 3 and computers 4 and 5 form a set of several communications participants communicating with each other via an instant messaging server 10. A wireless communication connection 11, 12 or 13 then exists between vehicle 1 and the instant messaging server 10, between vehicle 2 and the instant messaging server 10 and between the notebook 3 and the instant messaging server 10. A non-wireless communications connection 14 and 15 exists between the computer 4 and the instant messaging server 10, as well as between computer 5 and the instant messaging server 10. The communications connections 11 and 12 can be implemented, for example, as GPRS or CDMA2000 communications connections.

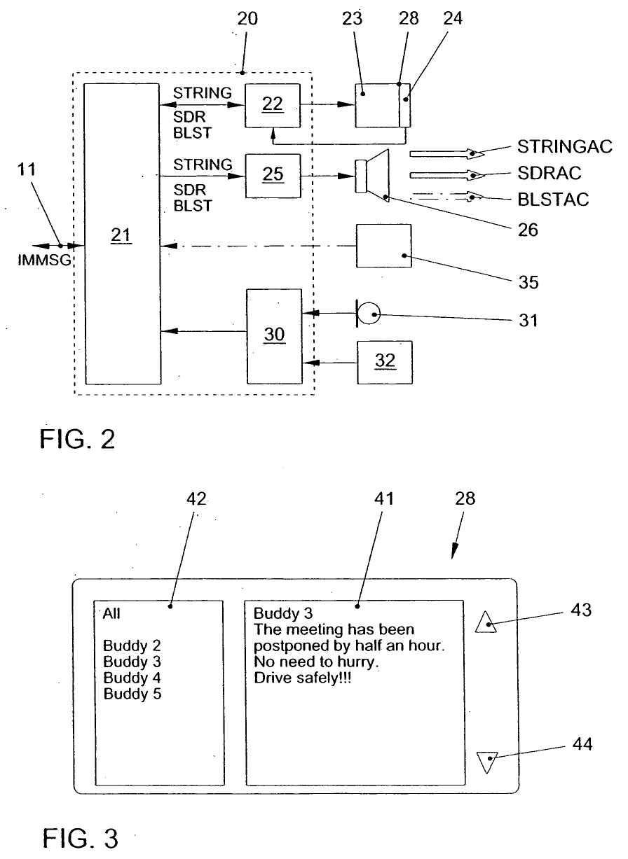

Vehicle 1 has an instant messaging communications system 20, depicted in FIG. 2, for communication between an occupant of the vehicle 1 and a communications participant, like vehicle 2, notebook 3, computer 4 or computer 5, or a driver or occupant of vehicle 2, or an operator of notebook 3, computer 4 or computer 5, via the instant messaging server 10. The instant messaging communications system 20 includes a communications module 20, partly implemented by means of JBuddy from Zion Software, to receive and send instant messaging messages IMMSG, including a message string STRING. The communications module 21 has an interface for a communications connection 11, implemented as CDMA2000, can include, for example, a PCMACIA Merlin C201 interface. The instant messaging communication system 20 also includes a text-to-speech engine 25 for translation of the message string STRING to an acoustic signal MSGAC with the information content of the message string STRING, which can be emitted by a loudspeaker 26. It is also optionally prescribed that the name SDR of the sender of the instant messaging message IMMSG is translatable to an acoustic signal SDRAC and can be emitted by means of a loudspeaker 26. A text-to-speech engine can be acquired, for example, from AT&T.

In an optional embodiment, a buddy list BLST can be translated into an acoustic signal BLSTAK by means of the text-to-speech engine 25 and emitted by loudspeaker 26. Buddy list, with reference to instant messaging, can be understood to mean a list of other communications participants, who are online and therefore available for exchange of instant messaging messages. According to the present practical example, the entries of the buddy list for the vehicle 1 are the names of vehicle 2, notebook 3, computer 4 and computer 5 or their users. It can be prescribed that emission of acoustic signal BLSTAK only occurs if an optionally implemented key 35 is pressed.

In an optional embodiment to vehicle 1 includes a display device 28, controllable by means of a display control 22 with a display 23 to display the message string STRING, the name SDR of the sender of the instant messaging message IMMSG an the buddy list BLST, and with a touch screen 24 arranged on display 23. FIG. 3 shows an embodiment of a display on the display device 28. Reference number 41 there denotes a message display field to depict the message string STRING and the name SDR of the sender of the instant messaging message IMMSG. If several instant messaging messages are present, these can be scrolled by touching the touch screen 24 in the region of triangles 43 and 44. Reference number 42 denotes a buddy list display field to depict the buddy list BLST and an additional selection line ALL. “Buddy 2”, “Buddy 3”, “Buddy 4” and “Buddy 5” denote the entries of the buddy list BLST, “Buddy 2” being the name of vehicle 2 or its operator, “Buddy 3” the name of notebook 3 or its operator, “Buddy 4” the name of computer 4 or its operator and “Buddy 5” the name of the computer 5 or its operator.

In an optional embodiment, it can be prescribed that by touching a position on touch screen 24, beneath which an entry “Buddy 2”, “Buddy 3”, “Buddy 4” or “Buddy 5” of the buddy list is displayed, the entry “Buddy 2”, “Buddy 3”, “Buddy 4” or “Buddy 5” of the buddy list BLST can be selected as the receiver of an instant messaging message to be sent or an email. By touching a position on touch screen 24, beneath which the additional selection line ALL is displayed, all entries of the buddy list BLST are selected as a receiver of an instant messaging message to be sent.

However, it is ordinarily prescribed that instant messaging messages, in principle, can only be sent to all entries of the buddy list (so-called broadcast method).

By touching a position on touch screen 24 in the region of the message display field 41 and/or the buddy list display field 42, and/or by operating an optional push-to-talk key 32, depicted in FIG. 2, the recording of a message by means of a microphone 31 for conversion of a speech signal to an electrical recording signal is initiated. The instant messaging communications system 20 includes a conversion module 30 to convert the electrical recording signal to a file, especially an MP3 file.

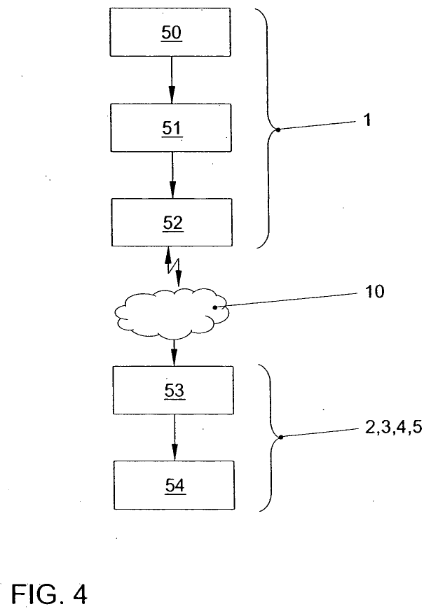

FIG. 4 shows this method. Reference number 50 denotes a step, in which a message is recorded by means of microphone 31. Step 50 is followed by step 51, in which the electrical recording signal is converted by conversion module 30 to a file, especially an MP3 file. In a subsequent step 52, an instant messaging message is transmitted with the file as an attachment by the communications module 21 to the instant messaging server 10. The instant messaging server 10 sends the instant messaging message, with the file as an attachment, to vehicle 2, notebook 3, computer 4 and computer 5. In a step 53, the instant messaging message is received, with the file as attachment, by vehicle 2, notebook 3, computer 4 and computer 5 and displayed as a received message in a subsequent step 54. A user of notebook 3, computer 4 and computer 5 can listen to the contents of the file, for example, by double-clicking a corresponding symbol.

In an alternative embodiment, the conversion module 30 is replaced by speech recognition, which converts a signal to a format that can be displayed as text. In this case, this text is a component of a normal instant messaging message.

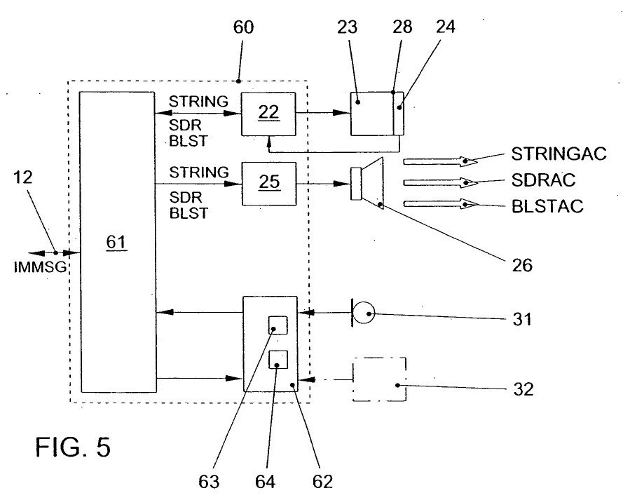

FIG. 5 shows an alternative instant messaging communication system 60, implemented, for example, on vehicle 2, for communication between an occupant of vehicle 2 and a communications participant, like vehicle 1, notebook 3, computer 4 or computer 5, or a driver or occupant of vehicle 1 and/or an operator of notebook 3, computer 4 and/or computer 5, via instant messaging server 10. The same reference numbers then denote elements equivalent to those in FIG. 2. The instant message communications system 60 includes a communications module 61 to receive and send instant messaging messages IMMSG, comprising in message string STRING. The instant messaging communications system 60 also includes a conversion module 62 to convert an electrical recording signal generated by means of microphone 31 to a file, especially an MP3 file.

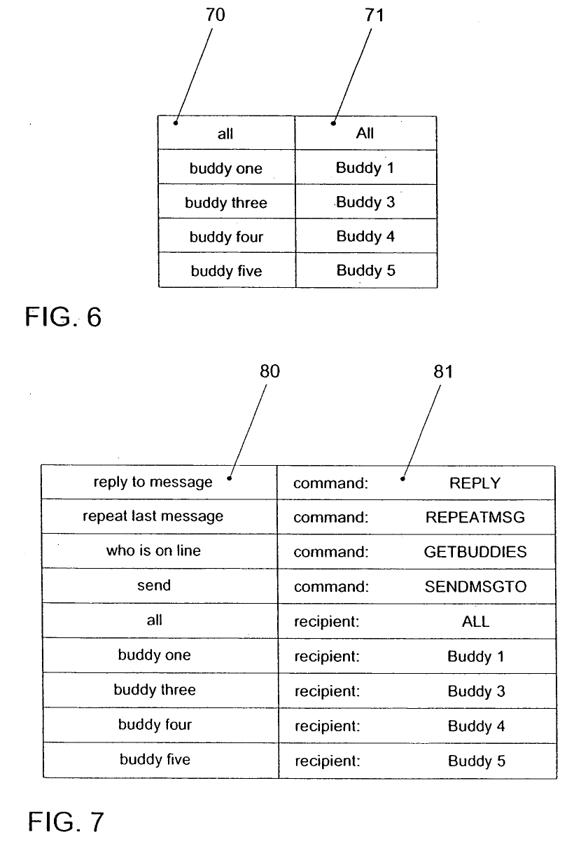

The conversion module 62 has a translation module 63 to translate an entry Buddy 1, Buddy 3, Buddy 4 or Buddy 5 (cf. reference numbers 71 and 81 in FIG. 6 and FIG. 7), of the buddy list BLST from an alphanumeric form to acoustic information “buddy one”, “buddy three”, “buddy four” or “buddy five” allocated to the entry of the buddy list, denoted with reference numbers 70 and 80 in FIG. 6 and FIG. 7. The acoustic information “buddy one”, “buddy three”, “buddy four” or “buddy five”, assigned to the entry of the buddy list and designated with reference numbers 70 and 80 in FIG. 6 and FIG. 7, are compared, by means of a selection module 64, to a signal recorded by means of microphone 31 and, with sufficient agreement, are chosen as receiver of an instant messaging message or an email to be sent. Accordingly, the selection option “ALL” can be used to select all entries of the buddy list BLST.

Accordingly, also with reference to FIG. 7, the depicted commands like REPLY can be used to answer the last message, REPEATMSG for acoustic repetition of a message or the last message, GETBUDDIES for acoustic emission of the buddy list and/or SENDMSGTO to send a message. During sufficient agreement of a signal recorded by means of microphone 31, with an acoustic information assigned to a command and designated with reference number 80 “reply to message”, “repeat last message”, “who is online” and “send”, this command 81 is executed. The duration of speech recording can be displayed to the instant messaging communications system 60 by pressing an optionally push-to-talk key 32.

The translation module 63 is designed as a so-called grapheme-to-phoneme engine. Details of a method conducted by means of grapheme-to-phoneme engine can be gathered, for example, from the article “Grapheme-to-phoneme conversion, a knowledge based approach” by Niklas Torstensson, Dept. of Languages, Skövde College, TMH-QPSR Vol. 44—Fonetik 2002, published on the Internet page www2.rz.huberlin.de/compling/Lehrstuhl/Skripte/CL_{—}2_Speech/Speech-98-121.pdf and on the Internet page www.speech.kth.se/qpsr/tmh/2002/02-44-117-120.pdf. Additional details of a method conducted with a grapheme-to-phoneme engine are disclosed in the article “Data-oriented Methods for Grapheme-to-Phoneme Conversion”, by Antal van den Bosch and Walter Daelemans, ITK, Tilburg University, published on the Internet page acl.ldc.upenn.edu/E/E93/E93-1007.pdf, and on the Internet page www.ub.rug.nl/eldoc/dis/science/i.p.stoianov/c5.pdf

Choice of a menu point by touching a touch screen according to the invention can comprise simple or easy touching of the touch screen by an operator. Selection of a menu point by touching a touch screen, however, preferably includes pressing on the touch screen, whereas slight touching of a touch screen does not lead to selection of a menu point. The latter implementation is particularly suited for use of the invention.

1. A vehicle containing an instant messaging communication system for communication between an occupant of the vehicle and a communications participant via an instant messaging server; the instant messaging communications system, comprising:
a communications module to receive an instant messaging message, comprising a message string; and
a text-to-speech engine to translate the message string to an acoustic signal.

2. The vehicle according to claim 1, the vehicle additionally comprising:
a loudspeaker to emit the acoustic signal.

3. The vehicle according to claim 1, wherein a name of a sender of the instant messaging message can be translated to an acoustic signal by means of the text-to-speech engine.

4. The vehicle according to claim 1, wherein a buddy list can be translated into an acoustic signal by means of the text-to-speech engine.

5. The vehicle according to claim 1, the vehicle additionally comprising:
a display to display the message string.

6. The vehicle according to claim 5, the vehicle additional comprising:
a touch screen arranged on the display, in which, by touching a position on the touch screen, beneath which the message string is displayed, a sender of the instant messaging message can be selected as receiver of an instant messaging message to be sent.

7. The vehicle according to claim 1, the vehicle also comprising:
a display to display a buddy list.

8. The vehicle according to claim 7, the vehicle additionally comprising:
a touch screen arranged on the display, in which, by touching a position on the touch screen, beneath which an entry of the buddy list is displayed, said entry can be selected as the buddy list receiver of an instant messaging message to be sent.

9. The vehicle according to claim 1, the vehicle additionally comprising:
a microphone to convert a speech signal to an electrical recording signal.

10. The vehicle according to claim 9, the instant messaging communications system additionally comprising:
a conversion module to convert the electrical recording signal to a file.

11. The vehicle according to claim 10, in which the file is an MP3 file.

12. The vehicle according to claim 1, the instant messaging communications system additionally comprising:
a translation module to translate an entry of a buddy list from an alphanumeric form into acoustic information assigned to the entry of the buddy list; and
a selection module to compare a signal recorded by means of a microphone with the acoustic information assigned to the entry of the buddy list, and to select the entry of the buddy list as a receiver of an instant messaging message to be sent during essential agreement of the signal recorded by means of a microphone with the acoustic information assigned to the entry of the buddy list.

13. A vehicle comprising an instant messaging communication system for communication between an occupant of the vehicle and a communications participant via an instant messaging server, having a communications module to receive an instant messaging message, comprising a message string, a text-to-speech engine to translate the message string to an acoustic signal, a display to display the message string, and a loudspeaker to emit the acoustic signal.

14. The vehicle according to claim 13, wherein a name of a sender of the instant messaging message can be translated to an acoustic signal by means of the text-to-speech engine.

15. The vehicle according to claim 13, wherein a buddy list can be translated into an acoustic signal by means of the text-to-speech engine.

16. The vehicle according to claim 13, comprising:
a touch screen arranged on the display, in which, by touching a position on the touch screen, beneath which the message string is displayed, a sender of the instant messaging message can be selected as receiver of an instant messaging message to be sent.

17. The vehicle according to claim 13, comprising:
a display to display a buddy list.

18. The vehicle according to claim 17, comprising:
a touch screen arranged on the display, in which, by touching a position on the touch screen, beneath which an entry of the buddy list is displayed, said entry can be selected as the buddy list receiver of an instant messaging message to be sent.

19. The vehicle according to claim 13, comprising:
a microphone to convert a speech signal to an electrical recording signal.

20. The vehicle according to claim 19, wherein the instant messaging communications system comprises a conversion module to convert the electrical recording signal to a file.
